(19) United States
(12) Patent Application Publication
(10) Pub. No.: US 2014/0028016 A1
(43) Pub. Date: Jan. 30, 2014

(54) ROTARY UNION FOR USE WITH A FLUID CONDUIT

(71) Applicant: Dana Heavy Vehicle Systems Group, LLC, Maumee, OH (US)

(72) Inventor: Brian V. Knapke, Toledo, OH (US)

(21) Appl. No.: 13/951,131

(22) Filed: Jul. 25, 2013

Related U.S. Application Data
(60) Provisional application No. 61/677,028, filed on Jul. 30, 2012.

(51) Int. Cl. F16L 17/02; F16L 27/087

(52) U.S. Cl. CPC F16L 17/02; F16L 27/087
USPC 285/98

(57) ABSTRACT

A rotary union is provided. The rotary union includes a first housing portion, a second housing portion, and a sealing member. The first housing portion has a first fluid passage formed therein and the second housing portion has a second fluid passage formed therein. The second fluid passage is in fluid communication with the first fluid passage. The sealing member is disposed on one of the first housing portion and the second housing portion and is sealingly engaged with a remaining one of the first housing portion and the second housing portion in a substantially similar direction to an axis of rotation of one of the first housing portion and the second housing portion. The rotary union permits axial deviation between a rotating component and a non-rotating component, reduces friction generated within the rotary union, and permits an increased flow rate of a fluid through the rotary union.

### CLAIM OF PRIORITY

The present application claims the benefit of and incorporates by reference U.S. Provisional Application No. 61/677,028 filed Jul. 30, 2012, entitled “ROTARY UNION FOR USE WITH A FLUID CONDUIT.”

### FIELD OF THE INVENTION

The invention relates to rotary unions forming a portion of a fluid conduit and, more particularly, to a rotary union for use with a tire inflation system that facilitates delivery of a pressurized fluid, such as air.

### BACKGROUND OF THE INVENTION

Tire inflation systems for vehicles are well-known and are used to provide a vehicle with versatility for differing terrain types or to reduce maintenance requirements. For example, a pressure of a plurality of tires in fluid communication with the tire inflation system may be lowered to provide additional traction for the vehicle and may be raised to reduce a rolling resistance of the vehicle. Further, the vehicle having the tire inflation system eliminates a need to periodically check a pressure within each tire and eliminates a need to adjust the pressure within each tire when the pressure within each tire requires adjustment.

A rotary union is used to enable fluid communication between a non-rotating component and a rotating component. The rotary union is in fluid communication with the tire inflation system and a wheel valve, to permit adjustments to be made to the pressure within each tire. The rotary union is typically disposed between an axle housing and a wheel hub; however, it is understood that the rotary union may also be disposed between an axle housing and a wheel shaft, between a steering knuckle and a wheel hub, or in other locations.

The rotary union typically includes two resilient seals directed radially inwardly or radially outwardly. An area between the seals forms a portion of a fluid conduit. Such an arrangement requires accurate alignment of an axis of the non-rotating component and an axis of the rotating component to maintain contact between each of the seals and a surface the seals are engaged with. To properly align the non-rotating component and the rotating component, each may be subjected to manufacturing operations of increased accuracy. Further, installation must be carefully performed to prevent damaging the rotary union. Such operations add cost to the vehicle the rotary union is incorporated in.

The resilient seals used in the rotary union may be pre-stressed by a reinforcing member. The reinforcing member may be disposed within the resilient seal or adjacent thereto to urge the resilient seal into the surface the seal is engaged with. Friction between the resilient seals and the surfaces the seals are engaged with results in excessive drag and heat generation. Further, a force applied by the reinforcing member is substantially constant regardless of a speed of the rotating component; which may result in the force applied by the reinforcing member to decrease at higher operational speeds.

The rotary union includes an inlet orifice and an outlet orifice. Typically, due to space limitations or manufacturing concerns, the inlet orifice and the outlet orifice have small cross-sectional areas. Consequently, a flow rate of a fluid through the rotary union may be limited. When the rotary union is incorporated into the vehicle having the tire inflation system, a limited flow rate through the rotary union may increase a duration required to adjust the pressure within the plurality of tires. The limited flow rate through the rotary union may also limit a size or a number of tires that may be inflated using the rotary union. Such deficiencies may result in dissatisfaction with the tire inflation system.

It would be advantageous to develop a rotary union that may be used with a tire inflation system that permits axial deviation between a rotating component and a non-rotating component, reduces friction generated between a resilient seal and a sealing surface of the rotary union, and permits an increased flow rate of a fluid through the rotary union.

### SUMMARY OF THE INVENTION

Presently provided by the invention, a rotary union that may be used with a tire inflation system has been developed that permits axial deviation between a rotating component and a non-rotating component, reduces friction generated between a resilient seal and a sealing surface of the rotary union, and permits an increased flow rate of a fluid through the rotary union.

In one embodiment, the present invention is directed to a rotary union comprising a first housing portion, a second housing portion, and a first sealing member. The first housing portion has a first fluid passage formed therein. The second housing portion has a second fluid passage formed therein. The second fluid passage is in fluid communication with the first fluid passage. The first sealing member is disposed on one of the first housing portion and the second housing portion. The first sealing member is sealingly engaged with a remaining one of the first housing portion and the second housing portion. The first sealing member contacts the remaining one of the first housing portion and the second housing portion in a substantially similar direction to an axis of rotation of one of the first housing portion and the second housing portion.

In another embodiment, the present invention is directed to a rotary union comprising a first housing portion, a second housing portion, a first sealing member, and a second sealing member. The first housing portion has a first fluid passage formed therein. The first housing portion comprises an annular sealing protuberance extending radially from a remaining portion of the first housing portion. The second housing portion has a second fluid passage formed therein. The second fluid passage is in fluid communication with the first fluid passage. The first sealing member has a substantially V-shaped cross-section and is disposed on the second housing portion. The first sealing member is sealingly engaged with the annular sealing protuberance of the first housing portion. The second sealing member has a substantially V-shaped cross-section and is disposed on the second housing portion. The second sealing member is sealingly engaged with the annular sealing protuberance of the first housing portion. The first sealing member and the second sealing member contact the first housing portion in a substantially similar direction to an axis of rotation of one of the first housing portion and the second housing portion.

The present invention is directed to a method of forming a rotary seal between a first housing portion and a second housing portion. The method comprises the steps of providing the first housing portion having a first fluid passage formed therein, providing the second housing portion having a second fluid passage formed therein, providing a first sealing member having a substantially V-shaped cross-section disposed on the second housing portion, the first sealing member sealingly engaged with the first housing portion, providing a second sealing member having a substantially V-shaped cross-section disposed on the second housing portion, the second sealing member sealingly engaged with the first housing portion, defining an annular cavity between the first housing portion, the second housing portion, the first sealing member, and the second sealing member, and applying a fluid pressure to one of the first fluid passage and the second fluid passage. The fluid pressure applies a force to a portion of each of the first sealing member and the second sealing member, which increases a seal contact pressure between each of the first and second sealing members and the first housing portion.

Various aspects of this invention will become apparent to those skilled in the art from the following detailed description of the preferred embodiment, when read in light of the accompanying drawings.

### BRIEF DESCRIPTION OF THE DRAWINGS

The above, as well as other advantages of the present invention, will become readily apparent to those skilled in the art from the following detailed description when considered in the light of the accompanying drawings in which:

FIG. 1 is a perspective view of a rotary union according to an embodiment of the invention;

FIG. 2 is a cross-sectional, perspective view of the rotary union shown in FIG. 1;

FIG. 3 is a cross-sectional, detail view of a portion of the rotary union shown in FIG. 1; and

FIG. 4 is a perspective view of a rotary union according to another embodiment of the invention.

### DETAILED DESCRIPTION OF THE INVENTION

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions, directions or other physical characteristics relating to the embodiments disclosed are not to be considered as limiting, unless the claims expressly state otherwise.

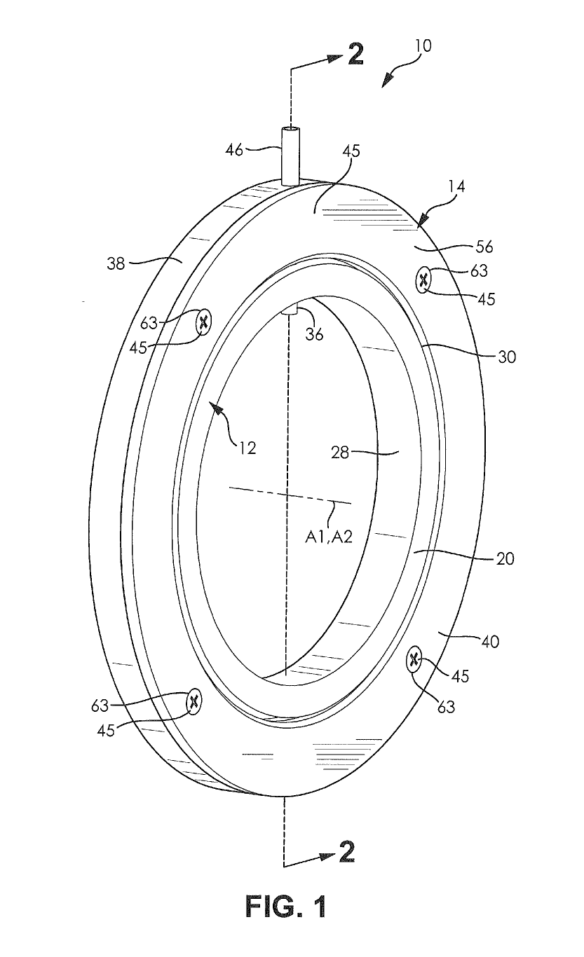

FIGS. 1-3 illustrate a rotary union 10 according to an embodiment of the invention. The rotary union 10 preferably comprises a first housing portion 12, a second housing portion 14, a first sealing member 16, and a second sealing member 18. As non-limiting examples, the rotary union 10 may form a portion of a tire inflation system (not shown), the rotary union 10 may form a portion of a wheel hub (not shown) of a vehicle (not shown), or the rotary union 10 may form a portion of an axle housing (not shown).

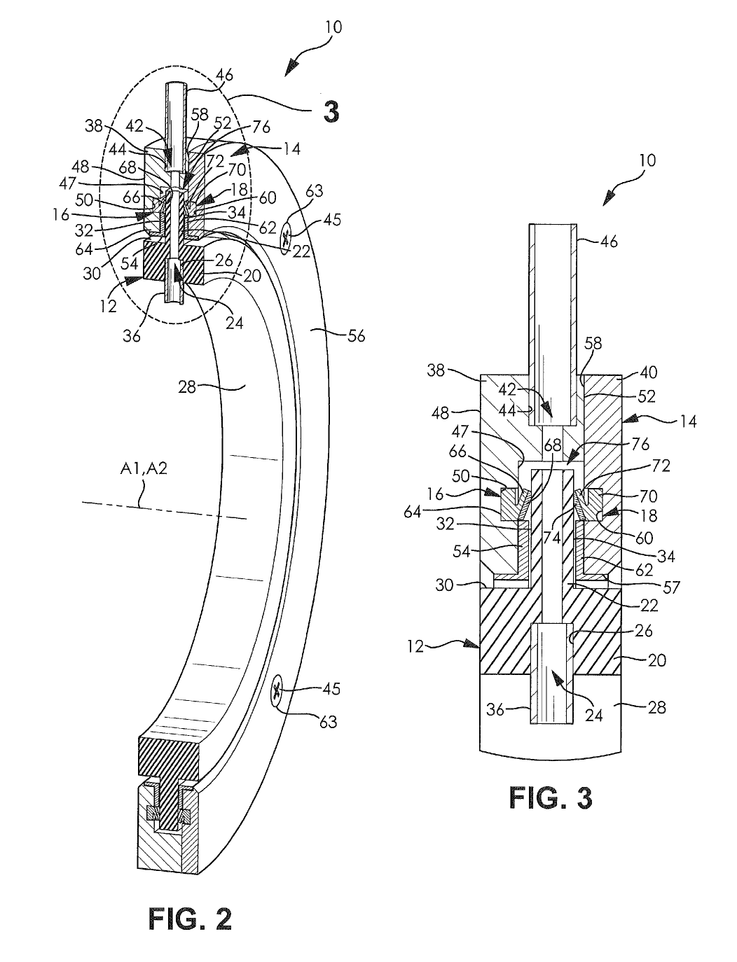

FIGS. 2 and 3 most clearly illustrate the first housing portion 12 of the rotary union 10. The first housing portion 12 is an annular member which may be disposed on one of a rotating component (not shown) and a non-rotating component (not shown). As non-limiting examples, the rotating component may be a portion of a wheel hub or a portion of a shaft and the non-rotating component may be a portion of an axle housing or a portion of a steering knuckle. Further, it is understood that the first housing portion 12 may be mounted in a floating manner when the second housing portion 14 is coupled to one of the rotating component and the non-rotating component. When the first housing portion 12 is mounted in a floating manner, a fitting, a bracket, or other member coupled to the first housing portion 12 and a remaining one of the rotating component and the non-rotating component facilitates or resists an application of torque to the first housing portion 12.

As illustrated, the first housing portion 12 includes a main portion 20, an annular sealing protuberance 22, a first conduit 24, and a first mounting aperture 26. Preferably, the first housing portion 12 is unitarily formed by casting and machining a metal; however, it is understood that the first housing portion 12 may be formed using other materials and processes. It is also understood that the first housing portion 12 may be formed by joining a plurality of components. The first conduit 24 and the first mounting aperture 26 are formed in the first housing portion 12.

The main portion 20 is an annulet having a rectangular shaped cross-section; however, it is understood that the main portion 20 may have other shapes. An inner face 28 of the main portion may include a fastening feature (not shown) formed thereon for engaging a corresponding fastening feature formed on one of the rotating component and the non-rotating component. As non-limiting examples, the fastening feature may be a thread, a tapered surface, or an aperture for receiving a fastener. An outer face 30 of the main portion 20 is spaced apart from the second housing portion 14 and defines the annular protuberance 22.

The annular protuberance 22 extends radially outwardly from the main portion 20 and has a rectangular shaped cross-section; however, it is understood the annular protuberance 22 may have other shapes. The annular protuberance 22 comprises a first sealing surface 32 and a second sealing surface 34.

The first sealing surface 32 is a planar, ring-shaped surface of the outer face 30. The first sealing surface 32 is oriented transverse to an axis Al of the first housing portion 12; however, it is understood that the first sealing surface 32 may be oriented substantially transverse to the axis Al of the first housing portion 12. The first sealing surface 32 is sealingly engaged with the first sealing member 16.

The second sealing surface 34 is a planar, ring-shaped surface of the outer face 30. The second sealing surface 34 is oriented transverse to the axis A1 of the first housing portion 12 and is parallel to the first sealing surface 32; however, it is understood that the second sealing surface 34 may be oriented substantially transverse to the axis Al of the first housing portion 12. The second sealing surface 34 is sealingly engaged with the second sealing member 18.

The first conduit 24 is a perforation formed through the main portion 20 and the annular sealing protuberance 22. The first conduit 24 permits fluid communication between the inner face 28 of the first housing portion 12 to the outer face 30 of the first housing portion 12. As shown in FIGS. 2 and 3, the first conduit 24 comprises a single perforation; however, it is understood that the first conduit 24 may comprise a plurality of perforations. When the first conduit 24 comprises a plurality of perforations, it is understood that a flow rate of a fluid through the main portion 20 of the rotary union 10 may be increased.

The first mounting aperture 26 is a portion of the first conduit 24 and is formed in the main portion 20. As shown in FIGS. 2 and 3, the first mounting aperture 26 is a stepped portion of the first conduit 24 and has a diameter greater than a diameter of a remaining portion of the first conduit 24; however, it is understood that the first mounting aperture 26 may have other shapes. The first mounting aperture 26 receives and is sealingly engaged with a fluid conduit 36. The fluid conduit 36 is in fluid communication with the tire inflation system. Alternately, the fluid conduit 36 may be in fluid communication with a valve (not shown) of one of a plurality of wheels (not shown) of the vehicle.

FIGS. 2 and 3 illustrate the second housing portion 14 of the rotary union 10. The second housing portion 14 is an annular member which may be disposed on one of a rotating component (not shown) and a non-rotating component (not shown). As non-limiting examples, the rotating component may be a portion of a wheel hub or a portion of a shaft and the non-rotating component may be a portion of an axle housing or a portion of a steering knuckle. Further, it is understood that the second housing portion 14 may be mounted in a floating manner when the first housing portion 12 is coupled to one of the rotating component and the non-rotating component. When the second housing portion 14 is mounted in a floating manner, a fitting, a bracket, or other member coupled to the second housing portion 14 and a remaining one of the rotating component and the non-rotating component facilitates or resists an application of torque to the second housing portion 14.

The second housing portion 14 includes a first portion 38, a second portion 40, a second conduit 42, and a second mounting aperture 44. The first portion 38 is sealingly coupled to the second portion 40 with a plurality of fasteners 45; however, it is understood, that the first portion 38 may be coupled to the second portion 40 in any conventional manner. When the first portion 38 is sealingly coupled to the second portion 40, the second housing portion 14 encloses a portion of the first housing portion 12. As shown in FIGS. 2 and 3, the second housing portion 14 encloses a portion of the annular protuberance 22 of the first housing portion 12. The second conduit 42 and the second mounting aperture 44 are formed in the first portion 38; however, it is understood that the second conduit 42 and the second mounting aperture 44 may be formed in the second portion 40 or the second conduit 42 and the second mounting aperture 44 may be formed in both the first portion 38 and the second portion 40. The second mounting aperture 44 receives and is sealingly engaged with a fluid conduit 46. The fluid conduit 46 is in fluid communication with the valve of one of a plurality of wheels of the vehicle. Alternately, the fluid conduit 46 may be in fluid communication with the tire inflation system. As shown in FIGS. 1 and 2, an axis A2 of the second housing portion 14 is substantially coincident to the axis Al of the first housing portion 12.

The first portion 38 is an annular member having a L-shaped cross-section; however, it is understood that the first portion 38 may have other shapes. The first portion 38 is formed by casting and machining a metal; however, it is understood that the first portion 38 may be formed using other materials and processes. It is also understood that the first portion 38 may be formed by joining a plurality of components. The first portion 38 includes an inner face 47, an outer face 48, a sealing member recess 50, a first mounting face 52, and a first friction pad 54.

The inner face 47 is an annular surface spaced apart from the outer face 30 of the annular sealing protuberance 22. As shown in FIGS. 2 and 3, the second conduit 42 is formed through the inner face 47. The outer face 48 is an annular surface having the second conduit 42 and the second mounting aperture 44 formed therethrough.

The sealing member recess 50 is an annular groove formed in the first portion 38. The first sealing member 16 is sealingly disposed in the sealing member recess 50. As most clearly shown in FIG. 3, the sealing member recess 50 has a substantially rectangular cross-sectional shape; however, it is understood that the sealing member recess 50 may have other cross-sectional shapes corresponding to a portion of the first sealing member 16. Further, it is understood that in embodiments of the invention not shown, the first portion 38 may not include the sealing member recess 50.

The first mounting face 52 is an annular surface which is disposed against and sealingly engages the second portion 40 when the second housing portion 14 is assembled. As shown in FIGS. 2 and 3, the first mounting face 52 is a planar, ring shaped surface oriented transversely to the axis A2 of the second housing portion 14; however, it is understood that the first mounting face 52 may have other shapes and orientations. When the first portion 38 is coupled to the second portion 40 using the plurality of fasteners 45, the first mounting face 52 defines a plurality of apertures (not shown) which receive the fasteners 45. Further, it is also understood that the first mounting face 52 may have recesses formed therein for receiving a sealing member, such as an O-ring, which sealingly engages the first mounting face 52 and the second portion 40.

The first friction pad 54 is a thin, annular member having a substantially L-shaped cross-section; however, it is understood that the first friction pad 54 may have other shapes. The first friction pad 54 is formed from a wear resistant, low friction thermoplastic; however, it is understood that the first friction pad 54 may be formed using other wear resistant, low friction materials. As a non-limiting example, the first friction pad 54 may be formed from polyoxymethylene. The first friction pad 54 is coupled to the inner face 47 of the first portion 38 using an adhesive; however it is understood that the first friction pad 54 may be coupled to the inner face 47 in any conventional manner. The first friction pad 54 is adjacent to but spaced apart from the first sealing surface 32 of the annular member 22 and the outer face 30 of the main portion 20. Alternately, it is understood that the first friction pad 54 may be formed by applying a coating of a material to the inner face 47. As a non-limiting example, the coating may be polytetrafluoroethylene. In embodiments of the invention not shown, the first friction pad 54 may be a thin, ring shaped member having a substantially rectangular shaped cross-section coupled to the inner face 47 and spaced apart from the first sealing surface 32 of the annular member 22 or the first friction pad 54 may comprise a plurality of annular members coupled to the inner face 47 or another part of the first portion 38.

The second portion 40 is an annular member having a substantially rectangular shaped cross-section; however, it is understood that the second portion 40 may have other shapes. The second portion 40 is formed by casting a metal; however, it is understood that the second portion 40 may be formed using other materials and processes. It is also understood that the second portion 40 may be formed by joining a plurality of components. The second portion 40 includes an outer face 56, an inner face 57, a second mounting face 58, a sealing member recess 60, and a second friction pad 62. The second portion 40 defines a plurality of perforations 63 therethrough which receive the fasteners 45 when the first portion 38 is coupled to the second portion 40. The outer face 56 is a planar, ring shaped surface oriented transversely to the axis Al of the first housing portion 12; however, it is understood that the outer face 56 may have other shapes and orientations.

The second mounting face 58 is an annular surface which is disposed against and sealingly engages the first mounting face 52 when the second housing portion 14 is assembled. As shown in FIGS. 2 and 3, the second mounting face 58 is a planar, ring shaped surface oriented transversely to the axis A1 of the first housing portion 12; however, it is understood that the second mounting face 58 may have other shapes and orientations. Further, it is also understood that the second mounting face 58 may have recesses formed therein for receiving a sealing member, such as an O-ring, which sealingly engages the first mounting face 52 and the second portion 40.

The sealing member recess 60 is an annular groove formed in the second mounting face 58. The second sealing member 18 is sealingly disposed in the sealing member recess 60. As most clearly shown in FIG. 3, the sealing member recess 60 has a substantially rectangular cross-sectional shape; however, it is understood that the sealing member recess 60 may have other cross-sectional shapes corresponding to a portion of the second sealing member 18. Further, it is understood that in embodiments of the invention not shown, the second portion 40 may not include the sealing member recess 60.

The second friction pad 62 is a thin, annular member having a substantially L-shaped cross-section; however, it is understood that the second friction pad 62 may have other shapes. The second friction pad 62 is formed from a wear resistant, low friction thermoplastic; however, it is understood that the second friction pad 62 may be formed using other wear resistant, low friction materials. As a non-limiting example, the second friction pad 62 may be formed from polyoxymethylene. The second friction pad 62 is coupled to the inner face 57 and the second mounting face 58 of the second portion 40 using an adhesive; however it is understood that the second friction pad 62 may be coupled to the inner face 57 and the second mounting face 58 in any conventional manner. The second friction pad 62 is adjacent to but spaced apart from the second sealing surface 34 and the outer face 30 of the main portion 20. Alternately, it is understood that the second friction pad 62 may be formed by applying a coating of a material to the inner face 57 and the second mounting face 58. As a non-limiting example, the coating may be polytetrafluoroethylene. In embodiments of the invention not shown, the second friction pad 62 may be a thin, ring shaped member having a substantially rectangular shaped cross-section coupled to the second mounting face 58 and spaced apart from the second sealing surface 34 of the annular member 22 or the second friction pad 62 may comprise a plurality of annular members coupled to the second mounting face 58 or the inner face 57 of the second portion 40.

The second conduit 42 is a perforation formed through the first portion 38. The second conduit 42 permits fluid communication between the inner face 47 and the outer face 48 of the first portion 38. As shown in FIGS. 2 and 3, the second conduit 42 comprises a single perforation; however, it is understood that the second conduit 42 may comprise a plurality of perforations. When the second conduit 42 comprises a plurality of perforations, it is understood that a flow rate of a fluid through the first portion 38 of the rotary union 10 may be increased.

The first sealing member 16, most clearly shown in FIG. 3, is an annular, resilient seal having a substantially V-shaped cross-section. The first sealing member 16 is coupled to the first portion 38 and includes a root portion 64, a lip portion 66, and a seal friction pad 68. The root portion 64 and the lip portion 66 are formed by molding an elastomer; however, it is understood that the root portion 64 and the lip portion 66 may be formed using other materials and processes. As a non-limiting example, the root portion 64 and the lip portion 66 may be formed from ethylene propylene diene monomer rubber.

The root portion 64 of the first sealing member 16 has a substantially rectangular shape and is disposed in the sealing member recess 50 of the first portion 38. A shape of the root portion 64 substantially corresponds to a shape of the sealing member recess 50; however, it is understood other shapes may be used.

The lip portion 66 of the first sealing member 16 has a substantially rectangular shape and is oriented obliquely with respect to the root portion 64 of the first sealing member 16; however, it is understood other shapes and orientations may be used. When the lip portion 66 is exposed to a laterally directed force through the seal friction pad 68 by the first sealing surface 32, the lip portion 66 is deflected towards the root portion 64, and applies a force to the first sealing surface 32. When the rotary union 10 is assembled the lip portion 66 is pretensioned by the laterally directed force applied to the lip portion 66 through the seal friction pad 68 by the first sealing surface 32.

The seal friction pad 68 is a thin, cone shaped member having a substantially rectangular shaped cross-section; however, it is understood that the seal friction pad 68 may have other shapes. The seal friction pad 68 is formed from a wear resistant, low friction thermoplastic; however, it is understood that the seal friction pad 68 may be formed using other wear resistant, low friction materials. As a non-limiting example, the seal friction pad 68 may be formed from polyoxymethylene. Alternately, it is understood that the seal friction pad 68 may be formed by applying a coating of a material to the lip portion 66. The seal friction pad 68 is integrally formed with the lip portion 66 of the first sealing member 16; however it is understood that the seal friction pad 68 may be coupled to the lip portion 66 in any conventional manner. The seal friction pad 68 is urged against the first sealing surface 32 by the lip portion 66 and is sealingly engaged with the first sealing surface 32.

The second sealing member 18, most clearly shown in FIG. 3, is an annular, resilient seal having a substantially V-shaped cross-section. The second sealing member 18 is coupled to the second portion 40 and includes a root portion 70, a lip portion 72, and a seal friction pad 74. The root portion 70 and the lip portion 72 are formed by molding an elastomer; however, it is understood that the root portion 70 and the lip portion 72 may be formed using other materials and processes. As a non-limiting example, the root portion 70 and the lip portion 72 may be formed from ethylene propylene diene monomer rubber.

The root portion 70 of the second sealing member 18 has a substantially rectangular shape and is disposed in the sealing member recess 60 of the second portion 40. A shape of the root portion 70 substantially corresponds to a shape of the sealing member recess 60; however, it is understood other shapes may be used.

The lip portion 72 of the second sealing member 18 has a substantially rectangular shape and is oriented obliquely with respect to the root portion 70 of the second sealing member 18; however, it is understood other shapes and orientations may be used. When the lip portion 72 is exposed to a laterally directed force through the seal friction pad 74 by the second sealing surface 34, the lip portion 72 is deflected towards the root portion 70, and applies a force to the second sealing surface 34. When the rotary union 10 is assembled the lip portion 72 is pretensioned by the laterally directed force applied to the lip portion 72 through the seal friction pad 74 by the second sealing surface 34.

The seal friction pad 74 is a thin, cone shaped member having a substantially rectangular shaped cross-section; however, it is understood that the seal friction pad 74 may have other shapes. The seal friction pad 74 is formed from a wear resistant, low friction thermoplastic; however, it is understood that the seal friction pad 74 may be formed using other wear resistant, low friction materials. As a non-limiting example, the seal friction pad 74 may be formed from polyoxymethylene. Alternately, it is understood that the seal friction pad 74 may be formed by applying a coating of a material to the lip portion 72. The seal friction pad 74 is integrally formed with the lip portion 72 of the second sealing member 18; however it is understood that the seal friction pad 74 may be coupled to the lip portion 72 in any conventional manner. The seal friction pad 74 is urged against the second sealing surface 34 by the lip portion 72 and is sealingly engaged with the second sealing surface 34.

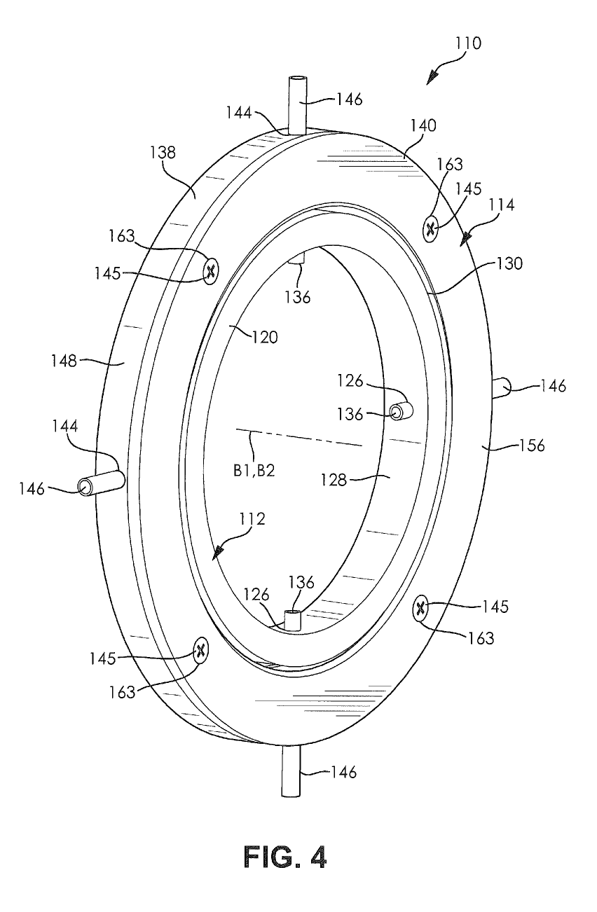

FIG. 4 shows an alternative embodiment of the rotary union 10. Similar features of the embodiment shown in FIG. 4 are referenced similarly, with the exception of the features described below.

FIG. 4 illustrates a rotary union 110 according to an embodiment of the invention. The rotary union 110 preferably comprises a first housing portion 112, a second housing portion 114, a first sealing member (not shown), and a second sealing member (not shown). While not shown in FIG. 4, it is understood that the first sealing member and the second sealing member of the rotary union 110 operate in a similar manner to the first sealing member 16 and second sealing member 18 of the rotary union 10. As non-limiting examples, the rotary union 110 may form a portion of a tire inflation system (not shown), the rotary union 110 may form a portion of a wheel hub (not shown) of a vehicle (not shown), or the rotary union 110 may form a portion of an axle housing (not shown).

The first housing portion 112 is an annular member which may be disposed on one of a rotating component (not shown) and a non-rotating component (not shown). As non-limiting examples, the rotating component may be a portion of a wheel hub or a portion of a shaft and the non-rotating component may be a portion of an axle housing or a portion of a steering knuckle. Further, it is understood that the first housing portion 112 may be mounted in a floating manner when the second housing portion 114 is coupled to one of the rotating component and the non-rotating component. When the first housing portion 112 is mounted in a floating manner, a fitting, a bracket, or other member coupled to the first housing portion 112 and a remaining one of the rotating component and the non-rotating component facilitates or resists an application of torque to the first housing portion 112.

The first housing portion 112 includes a main portion 120, an annular sealing protuberance (not shown), a plurality of first conduits (not shown), and a plurality of first mounting apertures 126. Preferably, the first housing portion 112 is unitarily formed by casting and machining a metal; however, it is understood that the first housing portion 112 may be formed using other materials and processes. It is also understood that the first housing portion 112 may be formed by joining a plurality of components. The plurality of first conduits and the plurality of first mounting apertures 126 are formed in the first housing portion 112.

The main portion 120 is an annulet having a rectangular shaped cross-section; however, it is understood that the main portion 120 may have other shapes. An inner face 128 of the main portion may include a fastening feature (not shown) formed thereon for engaging a corresponding fastening feature formed on one of the rotating component and the non-rotating component. As non-limiting examples, the fastening feature may be a thread, a tapered surface, or an aperture for receiving a fastener. An outer face 130 of the main portion 120 is spaced apart from the second housing portion 114 and defines the annular protuberance.

Each of the first conduits is a perforation formed through the main portion 20 and the annular sealing protuberance. Each of the first conduits permits fluid communication between the inner face 128 of the first housing portion 112 to the outer face 130 of the first housing portion 112, similar to the embodiment of the invention shown in FIGS. 1-3. The plurality of first conduits comprises four perforation; however, it is understood that the plurality of first conduits may comprise a fewer or a greater number of perforations.

Each of the first mounting apertures 126 is a portion of the first conduit and is formed in the main portion 120. Each of the first mounting apertures 126 is a stepped portion of the first conduit and has a diameter greater than a diameter of a remaining portion of the first conduit; however, it is understood that each of the first mounting apertures 126 may have other shapes. Each of the first mounting apertures 126 receives and is sealingly engaged with a fluid conduit 136. Each of the fluid conduits 136 is in fluid communication with the tire inflation system. Alternately, the plurality of fluid conduits 136 may be in fluid communication with a valve (not shown) of one of a plurality of wheels (not shown) of the vehicle.

FIG. 4 illustrates the second housing portion 114 of the rotary union 110. The second housing portion 114 is an annular member which may be disposed on one of a rotating component (not shown) and a non-rotating component (not shown). As non-limiting examples, the rotating component may be a portion of a wheel hub or a portion of a shaft and the non-rotating component may be a portion of an axle housing or a portion of a steering knuckle. Further, it is understood that the second housing portion 114 may be mounted in a floating manner when the first housing portion 112 is coupled to one of the rotating component and the non-rotating component. When the second housing portion 114 is mounted in a floating manner, a fitting, a bracket, or other member coupled to the second housing portion 114 and a remaining one of the rotating component and the non-rotating component facilitates or resists an application of torque to the second housing portion 114.

The second housing portion 114 includes a first portion 138, a second portion 140, a plurality of second conduits (not shown), and a plurality of second mounting apertures 144. The first portion 138 is sealingly coupled to the second portion 140 with a plurality of fasteners 145; however, it is understood, that the first portion 138 may be coupled to the second portion 140 in any conventional manner. When the first portion 138 is sealingly coupled to the second portion 140, the second housing portion 114 encloses a portion of the first housing portion 112. The second housing portion 114 encloses a portion of the annular protuberance of the first housing portion 112. Each of the second conduits and each of the second mounting aperture 144 are formed in the first portion 138; however, it is understood that each of the second conduits and each of the second mounting aperture 144 may be formed in the second portion 140 or each of the second conduits and each of the second mounting aperture 144 may be formed in both the first portion 138 and the second portion 140. Each of the second mounting apertures 44 receives and is sealingly engaged with a fluid conduit 146. Each of the fluid conduits 146 is in fluid communication with the valve of one of a plurality of wheels of the vehicle. Alternately, each of the fluid conduits 146 may be in fluid communication with the tire inflation system. As shown in FIG. 4, an axis B2 of the second housing portion 114 is substantially coincident to an axis B1 of the first housing portion 112.

The first portion 138 is an annular member having a L-shaped cross-section; however, it is understood that the first portion 138 may have other shapes. The first portion 138 is formed by casting and machining a metal; however, it is understood that the first portion 138 may be formed using other materials and processes. It is also understood that the first portion 138 may be formed by joining a plurality of components. The first portion 138 includes an inner face (not shown), an outer face 148, a sealing member recess (not shown), a first mounting face (not shown), and a first friction pad (not shown).

Each of the second conduits is a perforation formed through the first portion 138. Each of the second conduit permits fluid communication between the inner face and the outer face 148 of the first portion 138. The plurality of second conduits comprises four perforation; however, it is understood that the plurality of second conduits may comprise a fewer or a greater number of perforations.

While not shown in FIG. 4, it is understood that the first friction pad and a second friction pad of the rotary union 110 operate in a similar manner to the first friction pad 54 and the second friction pad 62 of the rotary union 10.

When the rotary union 110 comprises the plurality of first conduits and the plurality of second conduits, a total cross-sectional area of the first conduits and the second conduits may be increased when compared to a total cross-sectional area of the first conduit 24 and the second conduit 42 of the rotary union 10. When the total cross-sectional area of the first conduits and the second conduits are increased, the flow rate of the fluid through the rotary union 110 may be increased. Such an increase in the flow rate through the rotary union 110 may permit the tire inflation system to react to a system stimulus more quickly, may permit the vehicle to incorporate wheels having a greater volume, and may permit a plurality of wheels to be inflated through the rotary union 110.

In use, the rotary union 10, 110 permits axial deviation between the rotating component and the non-rotating component, reduces friction generated between sealing members 16, 18 and the sealing surfaces 32, 34 of the rotary union 10, 110, and permits an increased flow rate of a fluid through the rotary union 10, 110. When the rotary union 10, 110 is assembled, an annular cavity 76 is formed between the first housing portion 12, 112, the second housing portion 14, 114, the first sealing member 16, and the second sealing member 18.

When a pressurized fluid is applied to one of the fluid conduit 36, 46, 136, 146 and a remaining one of the conduits 36, 46, 136, 146 resists the pressurized fluid (such as applying the pressurized fluid to the valve of one of the plurality of wheels of the vehicle, for example), the annular cavity 76 of the rotary union 10, 110 is also pressurized. When the annular cavity 76 is pressurized, the pressure within the annular cavity 76 applies a force to each of the lip portions 66, 72, directing each of the lip portions 66, 72 respectively towards the sealing surfaces 32, 34. The forces applied to each of the lip portions 66, 72, by the pressure within the annular cavity 76 are also applied to each of the seal friction pads 68, 74, which increases a seal contact pressure between the seal friction pads 68, 74 and the sealing surfaces 32, 34. It is understood that the sealing members 16, 18 and the lip portions 66, 72 may be shaped to increase the seal contact pressure. Further, it is understood that the sealing members 16, 18 and a shape of the lip portions 66, 72 may be shaped to apply the seal contact pressure necessary to sealingly engage the seal friction pads 68, 74 with the sealing surfaces 32, 34 when the annular cavity 76 is pressurized with a pressure below a typical operating pressure used in the tire inflation system the rotary union 10, 110 is incorporated in.

The first housing portion 12, 112 may be disposed on one of the rotating component and the non-rotating component. The second housing portion 14, 114 is disposed on a remaining one of the rotating component and the non-rotating component. When the axes of the rotating component and the non-rotating component are not substantially aligned, and thus the axes A1, A2, B1, B2 of the first housing portion 12, 112 and the second housing portion 14, 114 are not substantially aligned, the rotary union 10, 110 permits fluid communication between the fluid conduit 36, 136 and the fluid conduit 46, 146. As a non-limiting example, it is understood that the rotary union 10, 110 may permit up to about 1 mm of misalignment between the axes A1, A2, B1, B2 of the first housing portion 12, 112 and the second housing portion 14, 114.

As a non-limiting example, when the first housing portion 12, 112 is disposed on the non-rotating component, the axis A2, B2 of the second housing portion 14, 114 may not be substantially aligned with the axis A1, B1 of the first housing portion 12, 112. However, because the first sealing member 16 and the second sealing member 18 respectively sealingly engage the first sealing face 32 and the second sealing face 34 in a direction substantially parallel to the axis A1, B1 of the first housing portion 12, 112, the second housing portion 14, 114 is free to move in a radially directed manner with respect to the first housing portion 12, 112 until the second housing portion 14, 114 contacts the first housing portion 12, 112. As a second non-limiting example, when the second housing portion 14, 112 is disposed on the non-rotating component, the axis A1, B1 of the first housing portion 12, 112 may not be substantially aligned with the axis A2, B2 of the second housing portion 14, 114. However, because the first sealing member 16 and the second sealing member 18 respectively sealingly engage the first sealing face 32 and the second sealing face 34 in a direction substantially parallel to the axis A2, B2 of the second housing portion 14, 114, the first housing portion 12, 112 is free to move in a radially directed manner with respect to the second housing portion 14, 114 until the first housing portion 12, 112 contacts the second housing portion 14, 114.

If one of the first housing portion 12, 112 and the second housing portion 14, 114 are subjected to an axial force, one of the first sealing surface 32 and the second sealing surface 34 may respectively contact the first friction pad 54 and the second friction pad 62. Friction generated by such contact is minimized by at least one of the first friction pad 54 and the second friction pad 62 and sealing engagement is maintained between the seal friction pads 68, 74 and the sealing surfaces 32, 34, and operation of the rotary union 10, 110 is unaffected by the axial force.

In accordance with the provisions of the patent statutes, the present invention has been described in what is considered to represent its preferred embodiments. However, it should be noted that the invention can be practiced otherwise than as specifically illustrated and described without departing from its spirit or scope.

What is claimed is:

1. A rotary union, comprising:
a first housing portion having a first fluid passage formed therein;
a second housing portion having a second fluid passage formed therein, the second fluid passage in fluid communication with the first fluid passage; and
a first sealing member disposed on one of the first housing portion and the second housing portion, the first sealing member sealingly engaged with a remaining one of the first housing portion and the second housing portion, wherein the first sealing member contacts the remaining one of the first housing portion and the second housing portion in a substantially similar direction to an axis of rotation of one of the first housing portion and the second housing portion.

2. The rotary union according to claim 1, further comprising a second sealing member disposed on one of the first housing portion and the second housing portion, the second sealing member sealingly engaged with a remaining one of the first housing portion and the second housing portion, the second sealing member contacting the remaining one of the first housing portion and the second housing portion in a substantially similar direction to the axis of rotation of one of the first housing portion and the second housing portion.

3. The rotary union according to claim 2, wherein the first housing portion is an annular member further comprising an annular sealing protuberance extending radially from a remaining portion of the first housing portion.

4. The rotary union according to claim 3, wherein the annular sealing protuberance comprises a first sealing surface and a second sealing surface, the first sealing surface and the second sealing surface oriented substantially transverse to the axis of rotation of one of the first housing portion and the second housing portion.

5. The rotary union according to claim 4, wherein the first sealing surface and the second sealing surface are planar, ring-shaped surfaces.

6. The rotary union according to claim 2, wherein the second housing portion is an annular member further comprising a first portion coupled to a second portion.

7. The rotary union according to claim 6, wherein the first portion coupled to the second portion of the second housing portion encloses a portion of the first housing portion.

8. The rotary union according to claim 6, wherein the first portion of the second housing portion has an L-shaped cross-section and the second portion of the second housing portion has a rectangular shaped cross-section.

9. The rotary union according to claim 2, wherein the second housing portion further comprises a first friction pad and a second friction pad, the first friction pad and the second friction pad spaced apart from first housing portion.

10. The rotary union according to claim 9, wherein the first friction pad and the second friction pad are formed from a wear resistant, low friction thermoplastic.

11. The rotary union according to claim 2, wherein the first sealing member and the second sealing member each have a substantially V-shaped cross-section.

12. The rotary union according to claim 11, wherein the first sealing member and the second sealing member each further comprise a seal friction pad.

13. The rotary union according to claim 12, wherein each of the seal friction pads is formed from a wear resistant, low friction thermoplastic.

14. The rotary union according to claim 11, wherein a portion of each of the first sealing member and the second sealing member are pretensioned against one of the first housing portion and the second housing portion by a laterally directed force.

15. The rotary union according to claim 11, wherein the first sealing member and the second sealing member each further comprise a seal friction pad.

16. The rotary union according to claim 2, wherein an annular cavity is defined between the first housing portion, the second housing portion, the first sealing member, and the second sealing member, the annular cavity facilitating one of the first housing portion and the second housing portion to move in a radial manner transverse to the axis of rotation of the remaining one of the first housing portion and the second housing portion.

17. The rotary union according to claim 2, further comprising a first fluid conduit sealingly engaged with the first housing portion and in fluid communication with the first fluid passage and a second fluid conduit sealingly engaged with the second housing portion and in fluid communication with the second fluid passage.

18. A rotary union, comprising:
a first housing portion having a first fluid passage formed therein, the first housing portion comprising an annular sealing protuberance extending radially from a remaining portion of the first housing portion;
a second housing portion having a second fluid passage formed therein, the second fluid passage in fluid communication with the first fluid passage; and
a first sealing member having a substantially V-shaped cross-section disposed on the second housing portion, the first sealing member sealingly engaged with the annular sealing protuberance of the first housing portion, and
a second sealing member having a substantially V-shaped cross-section disposed on the second housing portion, the second sealing member sealingly engaged with the annular sealing protuberance of the first housing portion, wherein the first sealing member and the second sealing member contact the first housing portion in a substantially similar direction to an axis of rotation of one of the first housing portion and the second housing portion.

19. The rotary union according to claim 18, wherein a portion of each of the first sealing member and the second sealing member are pretensioned against the first housing portion by a laterally directed force.

20. A method of forming a rotary seal between a first housing portion and a second housing portion, the method comprising the steps of:
providing the first housing portion having a first fluid passage formed therein;
providing the second housing portion having a second fluid passage formed therein;
providing a first sealing member having a substantially V-shaped cross-section disposed on the second housing portion, the first sealing member sealingly engaged with the first housing portion;
providing a second sealing member having a substantially V-shaped cross-section disposed on the second housing portion, the second sealing member sealingly engaged with the first housing portion;
defining an annular cavity between the first housing portion, the second housing portion, the first sealing member, and the second sealing member; and
applying a fluid pressure to one of the first fluid passage and the second fluid passage, wherein the fluid pressure applies a force to a portion of each of the first sealing member and the second sealing member, increasing a seal contact pressure between each of the first and second sealing members and the first housing portion.
